(19) United States
(12) Patent Application Publication
(10) Pub. No.: US 2025/0197593 A1
(43) Pub. Date: Jun. 19, 2025

(54) METHOD FOR RECYCLING AND REPROCESSING OF POLYURETHANE FOAMS BASED ON ACETOXIME

(71) Applicant: ZHEJIANG UNIVERSITY, HANGZHOU, Zhejiang Province (CN)

(72) Inventors: TAO XIE, HANGZHOU, ZHEJIANG PROVINCE (CN); ZENGHE LIU, HANGZHOU, ZHEJIANG PROVINCE (CN); ZIZHENG FANG, HANGZHOU, ZHEJIANG PROVINCE (CN); JINGJUN WU, HANGZHOU, ZHEJIANG PROVINCE (CN)

(21) Appl. No.: 18/437,864

(22) Filed: Feb. 9, 2024

(30) Foreign Application Priority Data
Dec. 15, 2023 (CN) 2023117297921

(51) Int. Cl. C08J 11/28; C08J 9/228

(52) U.S. Cl. CPC C08J 11/28; C08J 9/228; C08J 2201/02; C08J 2375/04

(57) ABSTRACT

The invention discloses a method for recycling and reprocessing of polyurethane foams based on acetoxime. The method comprises three steps: (1) Polyurethane foams are degraded into functionalized oligomers and/or small molecular compounds by adding acetoxime. (2) The obtained degradation products from step (1) are dispersed into acetoxime, and then are melted above the melting point of acetoxime, followed by being cooled down below the melting point of acetoxime, thus obtaining a mixture. (3) The mixture from step (2) is reprocessed into new polyurethane foams by vacuum sublimation. With this method, polyurethane wastes can be recycled and reprocessed into new foams and 3D printing products without consuming any reagent, or changing existing products and production infrastructures.

### FIELD OF TECHNOLOGY

The present invention pertains to the field of recycling and processing polyurethane foam. More particularly, the present invention is directed to a method for recycling and processing polyurethane foam based on acetoxime.

### BACKGROUND TECHNOLOGY

Polyurethane has a large degree of freedom in structural design and a wide range of adjustable performance. It is usually widely used in our lives in the form of foam, adhesive, sealant, leather, coating, fiber, and elastomer. Based on the previous reports, it is estimated that the global production volume of polyurethane has reached 29 million tons in 2019 (Plastics Europe. Plastics—The Facts 2020. Available online: https://plasticseurope.org/knowledge-hub/plastics-the-facts-2020/). Foam, as the main form of polyurethane, represents 67% of the global polyurethane production and is widely used in seat cushions, mattresses, sofas, pillows, buildings isolation, and commercial refrigeration (Y. Deng, et al. J. Environ. Manage. 2021, 278:111527. D. Simon, et al. Waste Manage. 2018, 76:147-171). Such a large volume couples with a heavily environmental burden after its service life.

Many efforts have been made to address this problem. The conventional physical recycling by thermo-compression process or using grounded particles as fillers is simple, but the amount is limited due to the degraded properties and low economical value. The conventional chemical recycling via glycolysis or aminolysis can recycle the original raw materials. However, it requires high reagent consumption, and can only recycle partial raw material polyol. The emerging chemical recycling that employs dynamic bonds enables thermal malleability and processability, but it usually requires special molecular design, and the form of the regenerated products is limited to film (X. Wang, et al. Green Chem. 2021, 23:307-313). These factors make them difficult to be practically implemented on a large scale.

### SUMMARY OF INVENTION

The present invention presents a method for recycling and reprocessing of polyurethane foams based on acetoxime, which does not require special molecular structure design, does not require changing existing production equipment, and does not require consuming any reagent, recycling polyurethane foam waste into new foam and 3D print products It can be implemented with ease, and has extremely high economic and social value.

The present invention provides the following technical solutions:
a method for recycling polyurethane foam based on acetoxime, the method includes the following steps:
(1) adding acetoxime to polyurethane foam for degradation reaction to obtain degradation products;
(2) dispersing the degradation product obtained in step (1) into acetoxime, heating to above the melting point of acetoxime to melt, and then cooling to below the melting point of acetoxime to obtain a mixture;
(3) performing vacuum sublimation on the mixture obtained in step (2) to obtain newly generated polyurethane foam.

The recycling objects of this invention focus on commodity polyurethane foams. On the basis of degradation of polyurethane foam wastes, it is further integrated with melting, cooling down, and vacuum sublimation process, thus obtaining new foams and 3D printing products.

In step (1), the dosage of acetoxime is 0.1-100 times of polyurethane foams. The degradation reaction temperature and time are 50-300° C. and 5 min-10 hours, respectively.

In step (1), in the degradation reaction, the urethane bonds, urea bonds, and biuret bonds in the polyurethane foam react with acetoxime. The functional groups of the degradation products include hydroxyl, amine, urea, and blocked isocyanate, etc. These groups are groups that can participate in reactions and reconstruct the molecular network. The degradation products are functional oligomers and/or small molecules, and the oligomers are linear, branched, or hyperbranched macromolecules.

In step (2), the melting temperature is 60-200° C., the cooling temperature is below 60° C.

In step (2), the mixture contains the crystalline phase of acetoxime, and the degradation products which is excluded or extruded from the acetoxime phase.

In step (2), the acetoxime can be released during the vacuum sublimation process, and can be further recycled easily by condensation.

In step (2), the functionalized degradation products are dispersed in excess acetoxime after the degradation reaction. The degradation system is melted (>60° C., the melting point of acetoxime) and poured into a mold. Then, it is cooled down (<60° C.) to crystallize acetoxime, at which the functionalized degradation products will be excluded or extruded from the acetoxime phase due to the crystallization.

In step (3), the temperature, time, and vacuum degree of the vacuum sublimation process are 80-250° C., 1 min-24 hours, and 0.001-0.1 MPa, respectively.

In step (3), the density and porosity of the newly generated foams and 3D-printed products are 5-1200 kg/m³, and 1-99%, respectively.

In step (3), the new foams are prepared by vacuum sublimation process coupled with the crosslinking reaction of the functionalized groups. Specifically, vacuum sublimation can obtain a porous structure, accompanied by the cross-linking reaction of functional degradation products: under vacuum conditions, hydroxyl, amine and urea bonds of the functionalized degradation products react with blocked isocyanate to form urethane, urea and biuret, respectively, thus reconstructing the crosslinked molecular network. The progress of the cross-linking reaction can also support the porous structure produced by vacuum sublimation.

The method for recycling polyurethane foam based on acetone oxime also includes: pouring them into mold after melting, and then removing the mold after cooling and obtaining the molded polyurethane foam after vacuum sublimation.

The method of recycling polyurethane foam based on acetone oxime also includes: adding a 3D printer after melting, performing extrusion molding, and performing vacuum sublimation after cooling to obtain a molded polyurethane foam/3D printed product.

The 3D-printed products have multi-level structures, including the macroscopic morphology, arranged and oriented filaments, porous structures interconnected along the direction of the filaments, and porous structures interconnected between the filaments. The first two structures can be controlled by the 3D printer, and the last two structures can be tuned by changing the dosage of acetoxime, the degradation reaction temperature and degradation reaction time, and the sublimation temperature, time, and vacuum degree. The multi-level structures can endow the materials a very wide range of adjustable properties, including density, porosity, mechanical properties, etc.

The performances of the newly generated foams and 3D-printed products can also be tuned by adding additives. The additives include, but are not limited to, isocyanate, blocked isocyanate, epoxy, acyl chloride, anhydride, carbonate, acrylate/methacrylate, allyl, vinyl, thiol, polyol, amine and other reagents. The additives are added before cooling down in step (2).

Compared with current recycling methods, the method provided by the present invention has the following advantages: (1) The present invention is suitable for all kinds of polyurethane foam, and require neither special molecular design, nor changing existing products and production infrastructures. (2) The present invention does not require consuming any reagent. (3) The recycled products are new foam and 3D printing products, and the performance can be adjusted in a very wide range.

### BRIEF DESCRIPTION OF THE DRAWINGS

FIG. 1 shows the degradation reaction of polyurethane foams.

FIG. 2 is a schematic diagram of reprocessing the degradation products to new foam with porous structure and reconstructed network.

FIG. 3 shows the crosslinking reaction of the degradation products during vacuum sublimation.

FIG. 4 shows the process flow diagram of recycling and reprocessing polyurethane foam.

FIG. 5 shows the photographs and SEM images of the initial molded polyurethane foam waste and the newly generated foam with low density in Example 1.

FIG. 6 shows the photographs and SEM images of the initial molded polyurethane foam waste and the newly generated foam with high density in Example 2.

FIG. 7 is a schematic diagram of reprocessing the degradation products towards 3D printing products in Example 3.

FIG. 8 shows the photographs and SEM images of the initial high-resilience polyurethane foam waste and the newly generated 3D printing products in Example 3.

### DETAILED EMBODIMENTS OF THE INVENTION

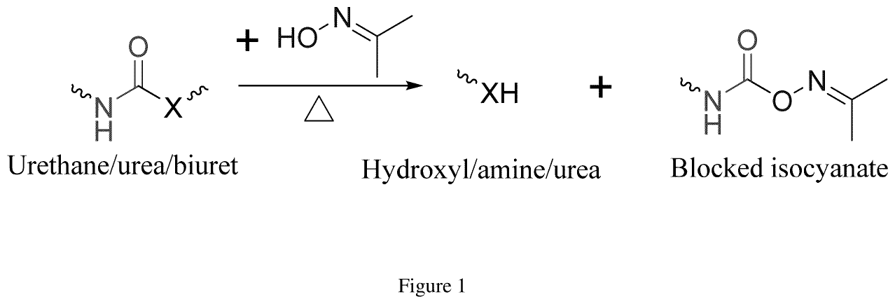

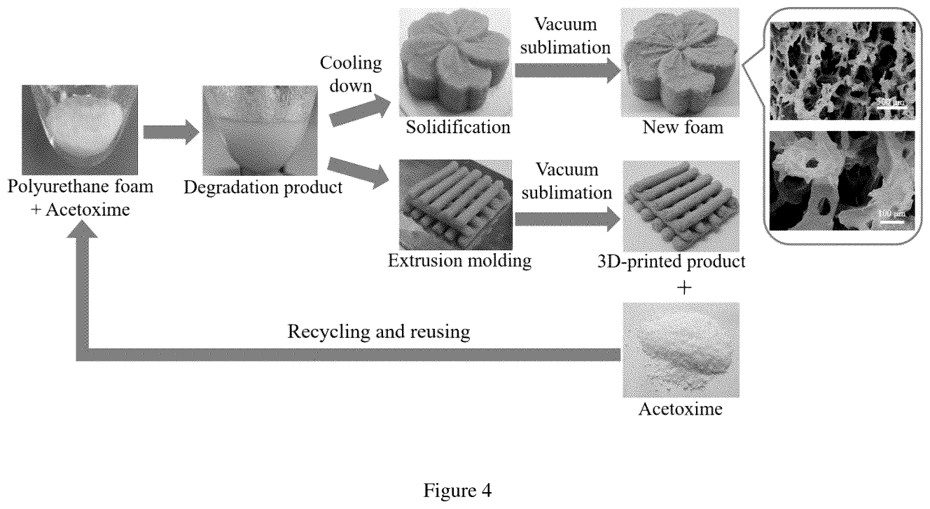

FIGS. 1-3 illustrate the mechanism of recycling and reprocessing polyurethane foam based on acetoxime, including the degradation reaction of polyurethane foams, the schematic diagram of the reaction in melting, cooling and vacuum sublimation of degradation products and acetoxime, and a schematic diagram of the degradation products during vacuum sublimation. FIG. 4 shows the preparation process of the method for recycling polyurethane foam based on acetoxime provided by the present invention. The method provided by the invention does not require special molecular structure design, nor does it require changing existing production equipment. At the same time, it does not require the consumption of any reagents, and can realize regenerated products into new foam or 3D printed products.

The present invention will be further described in detail with the following examples. It should be noted that the examples described below are intended to help understand the details of this invention. And the method should not be limited to these examples.

### Example 1 Recycling and Reprocessing Molded Polyurethane Foam Towards New Foam with Low Density

Raw materials: Molded polyurethane foam with a density of 60 kg/m³, UE Furniture Co., Ltd; Acetoxime, Macklin.

Degradation of the molded polyurethane foam: The molded polyurethane foam (10 g) was mechanically grounded and dried for 5 minutes at 150° C. in vacuum. Then, the vacuum gate valve was closed and acetoxime (400 g) was added. After heating at 150° C. for 20 minutes, the foam waste was completely liquefied to obtain a uniform solution.

Preparation of the new foam: The obtained degradation solution was melted at 80° C. and then poured into a mold. Then, it was cooled down at room temperature for 10 minutes to crystallize acetoxime. After removing the mold and conducting vacuum sublimation at 130° C. with a vacuum degree of 0.099 MPa for 2 hours, a new foam was obtained. In addition, the released acetoxime during the vacuum sublimation process was recycled by condensation.

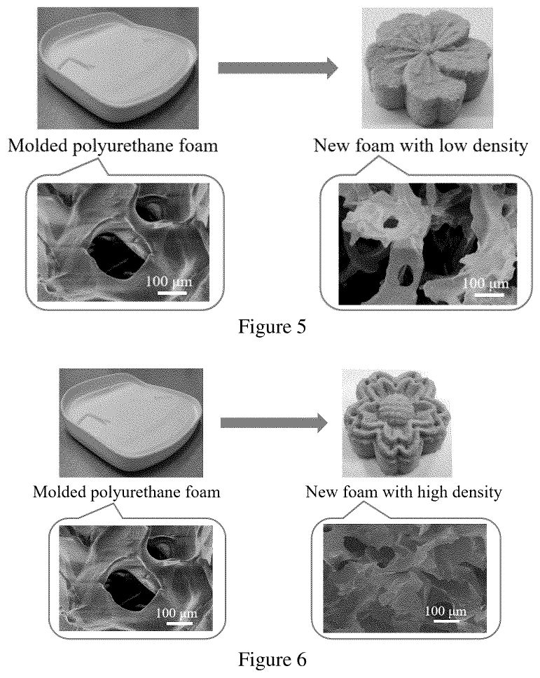

Performance characterization: The density of new low-density foam is 24 kg/m³. The compression modulus is 14 Kpa. The compressive strength under 80% strain is 32 KPa. The morphologies of the initial molded foam waste and the new regenerated foam are shown in FIG. 5.

### Example 2 Recycling and Reprocessing Molded Polyurethane Foam Towards New Foam with High Density

Raw materials: Molded polyurethane foam with a density of 60 kg/m³, UE Furniture Co., Ltd; Acetoxime, Macklin.

Degradation of the molded polyurethane foam: The molded polyurethane foam (10 g) was mechanically grounded and dried for 5 minutes at 150° C. in vacuum. Then, the vacuum gate valve was closed and acetoxime (20 g) was added. After heating at 150° C. for 120 minutes, the foam waste was completely liquefied to obtain a uniform solution.

Preparation of the new foam: The obtained degradation solution was melted at 80° C. and then poured into a mold. Then, it was cooled down at room temperature for 10 minutes to crystallize acetoxime. After removing the mold and conducting vacuum sublimation at 130° C. with a vacuum degree of 0.099 MPa for 0.5 hour, a new foam was obtained. In addition, the released acetoxime during the vacuum sublimation process was recycled by condensation.

Performance characterization: The density of new low-density foam is 352 kg/m³. The compression modulus is 208 Kpa. The compressive strength under 80% strain is 2.26 MPa. The morphologies of the initial molded foam waste and the new regenerated foam are shown in FIG. 6.

### Example 3 Recycling and Reprocessing High-Resilience Polyurethane Foam Towards 3D Printing Products

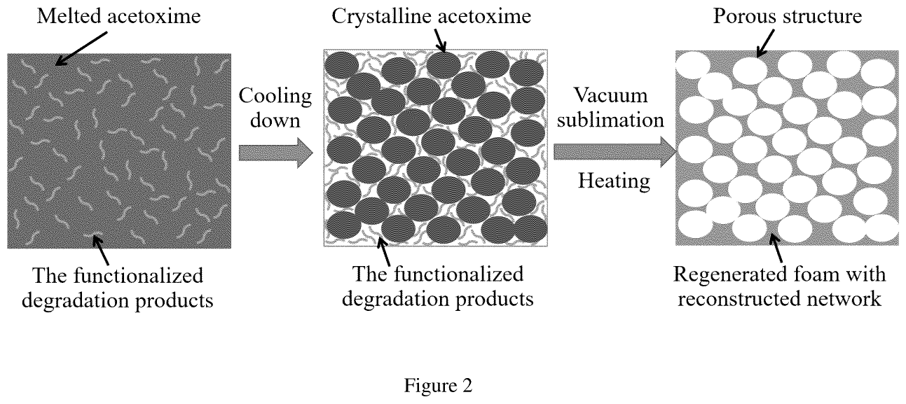

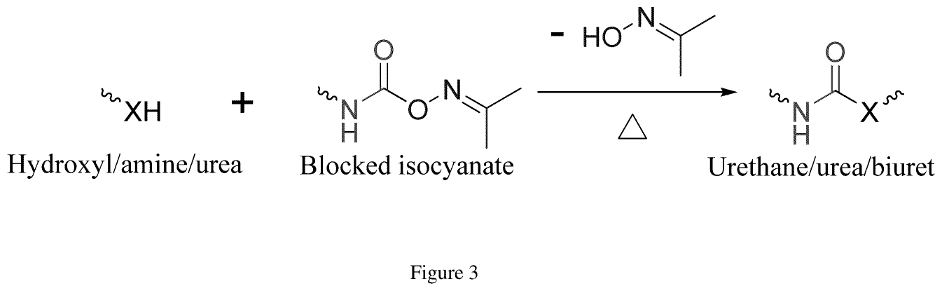

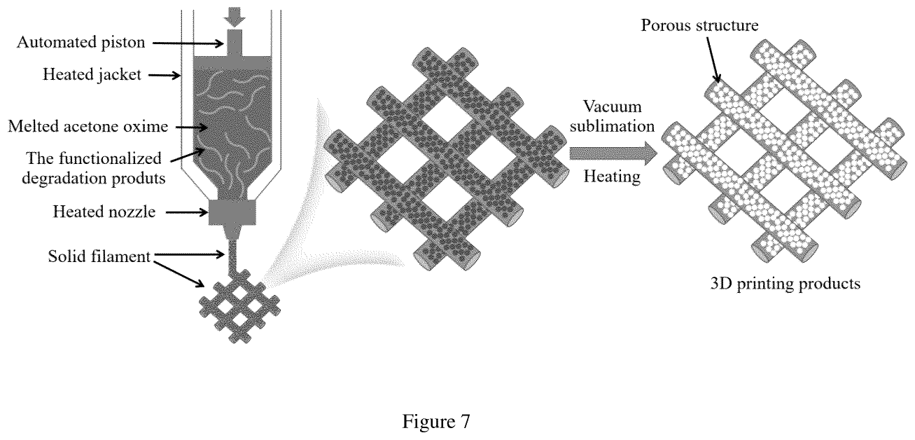

The mechanism of preparing 3D printing products: as shown in FIG. 7, the degradation system was melted at 60-200° C. and extruded under the control of a 3D printer. The extruded materials crystallize quickly to form solid filaments for the construction of 3D printing products. According to the program setup of the 3D printer, the extruded filaments are accumulated in layers to form the corresponding shape. After 3D printing, the materials undergo vacuum sublimation coupled with the crosslinking reaction of the functionalized groups in the same fashion as shown in FIG. 2 and FIG. 3.

The specifics of the present embodiment are as follows:

Raw materials: High-resilience polyurethane foam with a density of 35 kg/m³, UE Furniture Co., Ltd; Acetoxime, Macklin.

Degradation of the high-resilience polyurethane foam: The high-resilience polyurethane foam (10 g) was mechanically grounded and dried for 5 minutes at 150° C. in vacuum. Then, the vacuum gate valve was closed and acetoxime (200 g) was added. After heating at 150° C. for 30 minutes, the foam waste was completely liquefied to obtain a uniform solution.

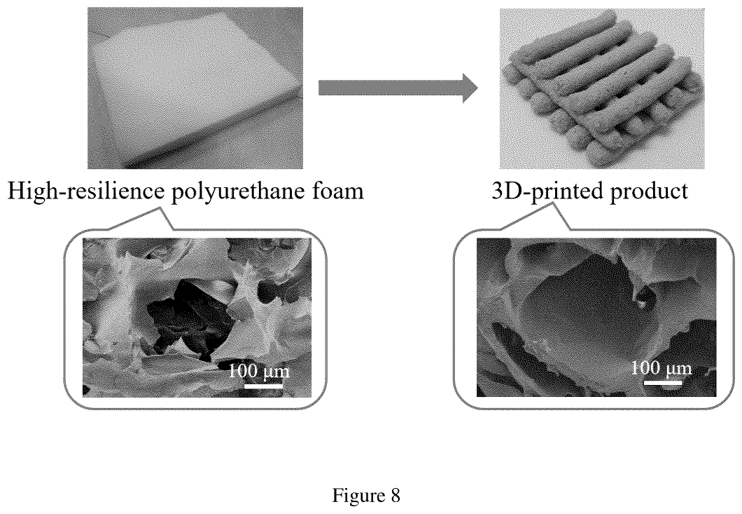

Preparation of 3D printing products: The obtained degradation solution was melted at 65° C. and then printed by a 3D printer. After conducting vacuum sublimation at 150° C. with a vacuum degree of 0.099 MPa for 1 hour, a 3D-printed product was obtained. In addition, the released acetoxime during the vacuum sublimation process was recycled by condensation. The morphologies of the foam waste and the new regenerated 3D-printed product are shown in FIG. 8.

Repeated recyclability: The generated 3D printed material was liquefied in the same fashion as the original foam and made into new resin for another round of 3D printing.

What is claimed is:

1. A method for recycling and reprocessing of polyurethane foams based on acetoxime comprising the following steps:
(1) adding acetoxime to polyurethane foam for degradation reaction to obtain degradation products;
(2) dispersing the degradation product obtained in step (1) into acetoxime, heating to above the melting point of acetoxime to melt, and then cooling to below the melting point of acetoxime to obtain a mixture;
(3) performing vacuum sublimation on the mixture obtained in step (2) to obtain newly generated polyurethane foam.

2. The method for recycling and reprocessing of polyurethane foams based on acetoxime according to claim 1, wherein in the step (1), the dosage of acetoxime is 0.1-100 times of polyurethane foams, and the degradation reaction temperature and time are 50-300° C. and 5 min-10 hours, respectively.

3. The method for recycling and reprocessing of polyurethane foams based on acetoxime according to claim 1, wherein in the step (1), the functional groups of the degradation products include hydroxyl, amine, urea, and blocked isocyanate, and the structure of the functionalized oligomer is linear, branched, or hyperbranched macromolecule.

4. The method for recycling and reprocessing of polyurethane foams based on acetoxime according to claim 1, wherein in the step (2), the melting temperature is 60-200° C., and the cooling temperature is below 60° C.

5. The method for recycling and reprocessing of polyurethane foams based on acetoxime according to claim 1, wherein in the step (2), the mixture contains the crystalline phase of acetoxime, and the degradation products are extruded from the acetoxime phase.

6. The method for recycling and reprocessing of polyurethane foams based on acetoxime according to claim 1, wherein in the step (2), an additive is added in the molten state, the additive is selected from isocyanate, blocked isocyanate, epoxy, acyl chloride, anhydride, carbonate, acrylate/methacrylate, allyl, vinyl, thiol, polyol, and amine.

7. The method for recycling and reprocessing of polyurethane foams based on acetoxime according to claim 1, wherein in the step (3), the temperature, time, and vacuum degree in the vacuum sublimation process are 80-250° C., 1 min-24 hour, and 0.001-0.1 MPa, respectively.

8. The method for recycling and reprocessing of polyurethane foams based on acetoxime according to claim 1, wherein in the step (3), the density and porosity of the newly generated foams are 5-1200 kg/m³, and 1-99%, respectively.

9. The method for recycling and reprocessing of polyurethane foams based on acetoxime according to claim 1, wherein in the step (2), molds are used for molding: pouring the degradation system into molds in the molten state, and then removing the molds in the cooling state, followed by conducting vacuum sublimation, and generating new polyurethane foams with various shapes.

10. The method for recycling and reprocessing of polyurethane foams based on acetoxime according to claim 1, wherein in the step (2), three-dimensional (3D) printer is used for molding: adding the degradation system into three-dimensional (3D) printer for extrusion molding in the molten state, and then cooling down, followed by conducting vacuum sublimation, and generating new polyurethane foams with various shapes.
